(19) United States
(12) Patent Application Publication
(10) Pub. No.: US 2026/0042422 A1
(43) Pub. Date: Feb. 12, 2026

(54) SYSTEMS AND METHODS FOR CONTROLLING OPERATION OF VEHICLE WIPERS

(71) Applicant: Ford Global Technologies, LLC, Dearborn, MI (US)

(72) Inventors: Mahmoud Yousef Ghannam, Canton, MI (US); Robert Schroeter, Livonia, MI (US); Justin Miller, Berkley, MI (US); Nicholas Colella, Grosse Ile, MI (US)

(73) Assignee: Ford Global Technologies, LLC, Dearborn, MI (US)

(21) Appl. No.: 18/797,350

(22) Filed: Aug. 7, 2024

(51) Int. Cl. B60S 1/08

(52) U.S. Cl. CPC B60S 1/0859; B60S 1/0807; B60S 1/0844

(57) ABSTRACT

A vehicle including a windshield, a sensor unit, a first wiper, a second wiper and a processor is disclosed. The sensor unit may be configured to determine inputs associated with a presence of water on the windshield in a sensor unit's field of view (FOV). The processor may determine a first amount of water added to the windshield in the sensor unit's FOV during a first time duration and a second amount of water added to the windshield in the sensor unit's FOV during a second time duration based on the inputs obtained from the sensor unit. The first and second time durations may be based on the movements of the first and second wipers on the windshield. The processor may further calculate a difference between the first amount and the second amount, and control an operation of the first and second wipers based on the difference.

### FIELD

The present disclosure relates to systems and methods for controlling operation of vehicle wipers by correlating a pattern of wiper movement with a vehicle rain sensor's field of view (FOV).

### BACKGROUND

Vehicles are equipped with windshield wipers (“wipers”) that wipe and clean the windshield when rain, snow, etc. may be falling on the windshield. Most modern vehicles additionally include rain sensors or rain sensing modules that detect presence of rainwater on the windshield. The rain sensors typically facilitate the vehicle in automatically activating and controlling wiper speed when the rain sensors detect rainwater on the windshield.

While conventional systems and methods for automatically controlling wiper movement provide benefits to vehicle operators, efforts are being made to further enhance the control of wiper movement by using inputs from existing rain sensors.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a block diagram of a system to control operation of vehicle wipers in accordance with the present disclosure.

FIG. 3 depicts an example sequence of wiper movement with time in accordance with the present disclosure.

FIG. 4 depicts example rain density values at different time durations of wiper movement in accordance with the present disclosure.

FIG. 5 depicts an example graph showing different rain density values at different cycles of wiper movement in accordance with the present disclosure.

FIGS. 6A and 6B depict a flow diagram of an example method to control operation of vehicle wipers in accordance with the present disclosure.

### DETAILED DESCRIPTION

### Overview

The present disclosure describes a vehicle that automatically controls wiper movement (e.g., wiper speed of a first wiper and a second wiper associated with the vehicle) on a vehicle's windshield based on an amount of water/rainfall that may be falling on the windshield. The vehicle may include a sensor unit (e.g., a rain sensor, a vehicle camera, etc.) that may capture inputs associated with a presence on water on the windshield in a sensor unit's field of view (FOV). The vehicle may control the wiper movement on the windshield based on the inputs obtained from the sensor unit. Specifically, the vehicle may control the wiper movement on the windshield based on rain densities or amount of water that falls on the windshield in the sensor unit's FOV during different time durations of wiper movement.

In some aspects, to optimally control the wiper movement, the vehicle may first determine, based on the inputs obtained from the sensor unit, different amounts of water that falls on the windshield in the sensor unit's FOV at different time durations of wiper movement. For example, the vehicle may determine, based on the sensor unit's inputs, that a first amount of water falls on the windshield in the sensor unit's FOV at a first time duration, a second amount of water falls on the windshield at a second time duration, a third amount of water falls on the windshield at a third time duration, and a fourth amount of water falls on the windshield at a fourth time duration. In some aspects, the first time duration may be a time required by the first wiper to enter the sensor unit's FOV from a first wiper's initial position, the second time duration may be a time required by the second wiper to re-enter the sensor unit's FOV after exiting the sensor unit's FOV, the third duration may be a time required by the second wiper to enter the sensor unit's FOV for a first time in a wiper movement cycle after the first wiper exits the sensor unit's FOV for the first time in the wiper movement cycle, and the fourth time duration may be a time required by the first wiper to enter the sensor unit's FOV a second time in the wiper movement cycle after the second wiper exits the sensor unit's FOV the second time in the wiper movement cycle.

The vehicle may compare the determined amounts of water described above for “similar” time durations within a single wiper movement cycle or across successive wiper movement cycles to effectively control the wiper movement on the windshield. For example, if the first time duration may be equivalent to the second time duration, the vehicle may compare the first amount with the second amount, within the same wiper movement cycle or across successive wiper movement cycles. Similarly, if the third time duration may be equivalent to the fourth time duration, the vehicle may compare the third amount with the fourth amount, within the same wiper movement cycle or across successive wiper movement cycles. The vehicle may determine that the rainfall may be increasing in intensity if the difference or delta between the amounts described above may be positive. In this case, the vehicle may increase the wiper speed.

Further, the vehicle may determine that the rainfall may be decreasing in intensity if the difference or delta between the amounts described above may be negative. In this case, the vehicle may decrease the wiper speed. Furthermore, the vehicle may determine that the rainfall may be steady if the difference or delta between the amounts described above may be equivalent to zero. In this case, the vehicle may maintain the wiper speed.

The vehicle may be further configured to determine whether the vehicle may be experiencing heavy rain or a splash of water (caused due to, e.g., another vehicle passing by or a water sprinkler) based on the comparison of the amounts of water described above. The vehicle may further perform wiper health diagnosis based on the comparison and output a maintenance notification when the vehicle determines that the first and/or second wipers may be faulty.

The present disclosure discloses a vehicle that effectively controls wiper movement on the windshield, based on accurate measure of the amount of water present on the windshield.

Since the vehicle determines the rain densities or amount of water on the windshield at different time durations of wiper movement and compares the rain densities associated with “similar” time durations, the determination of increasing/decreasing/steady rainfall is highly accurate, and hence the efficiency of wiper speed control is greatly enhanced. Further, by using the systems and methods described in the present disclosure, the wiper speed transitions can be made mid-wipe as opposed to having to wait until after a wipe is performed or a wiper movement cycle is completed. Furthermore, the vehicle performs wiper health evaluation and determines whether the first and/or second wipers may be faulty and accordingly notifies the vehicle operator so that wiper repair/replacement can be made in a timely manner.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

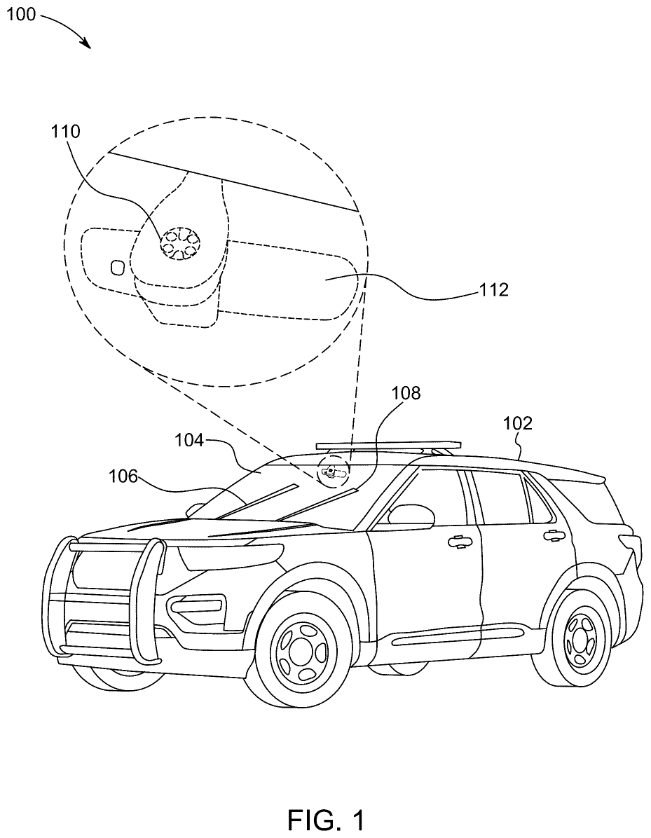

FIG. 1 depicts an example environment 100 in which techniques and structures for providing the systems and methods disclosed herein may be implemented. The environment 100 may include a vehicle 102 that may take the form of any passenger or commercial vehicle such as a car, a work vehicle, a crossover vehicle, a truck, a van, a minivan, a taxi, a bus, etc. The vehicle 102 may be a manually driven vehicle or may be configured to operate in a partially/fully autonomous mode. Further, the vehicle 102 may include any powertrain such as a gasoline engine, one or more electrically-actuated motor(s), a hybrid system, etc.

The vehicle 102 may include a front windshield 104 (or windshield 104) and a back windshield (not shown). The windshield 104 and the back windshield may enable a vehicle operator (not shown) sitting inside the vehicle 102 to conveniently view the area outside the vehicle 102 (e.g., road, incoming vehicles, buildings, etc.). The vehicle 102 may further include wipers that may be configured to wipe and clean respective windshields when rainwater, snow, ice, dust, etc. may be present on the windshields. For example, the vehicle 102 may include a first wiper 106 (e.g., a right wiper, when viewed from inside the vehicle 102) and a second wiper 108 (e.g., a left wiper) that may be configured to wipe water from the windshield 104 when the first wiper 106 and the second wiper 108 may be activated by the vehicle 102 (e.g., when rain may be falling on the windshield 104).

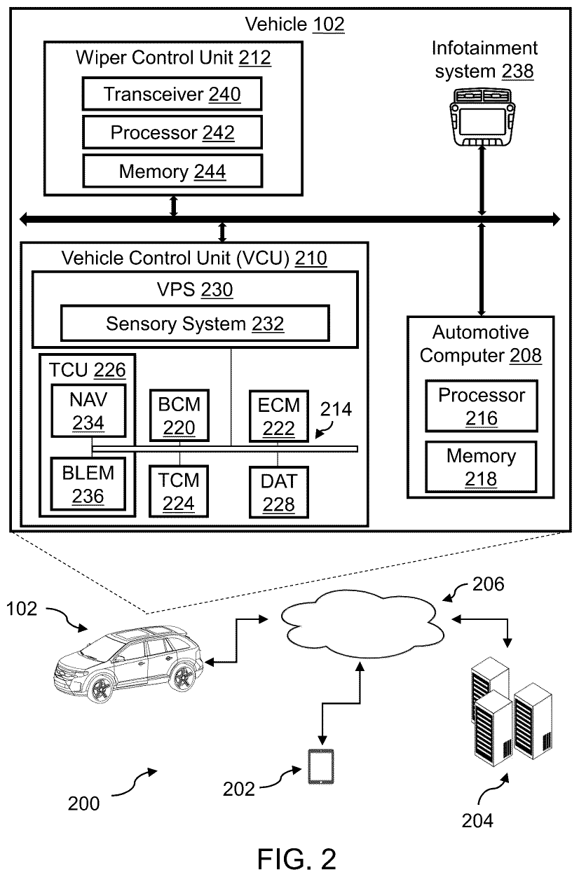

In an exemplary aspect, the first and second wipers 106, 108 may be configured to move from left-to-right and then from right-to-left simultaneously at the same speed in a “single cycle” of wiper movement to effectively wipe the windshield 104. In other aspects, the first and second wipers 106, 108 may move from right-to-left and then from left-to-right simultaneously at the same speed in a single cycle of wiper movement. In the present disclosure, the first and second wipers 106, 108 are described to move from left-to-right and then from right-to-left simultaneously at the same speed in a single cycle of wiper movement; however, such wiper movement in a cycle should not be construed as limiting. The concept of a “cycle” of wiper movement is described later in the description below in conjunction with FIG. 2.

The vehicle 102 may further include a sensor unit 110 configured to determine or capture inputs associated with a presence of water (or snow, dust, etc.) on the windshield 104 in a sensor unit's field of view (FOV). The sensor unit 110 may be, for example, a rain sensor, a vehicle camera, and/or the like. The vehicle 102 may be configured to determine a rain density or an amount of water present on or added to the windshield 104 in the sensor unit's FOV based on the inputs captured by the sensor unit 110. For example, when the sensor unit 110 is a rain sensor, the vehicle 102 may determine the rain density based on a signal strength of a signal emitted by the rain sensor and reflected back from the water droplets present on the windshield 104. As another example, when the sensor unit 110 is a vehicle camera, the vehicle 102 may determine the rain density based on a heat map of pixels associated with windshield images (including water droplet images) captured by the vehicle camera.

In the exemplary aspect depicted in FIG. 1, the sensor unit 110 is shown to be disposed on a back side of a vehicle's rear view mirror 112 at a center top portion of the windshield 104, so that the sensor unit 110 may effectively capture the inputs (e.g., signals, images, etc.) associated with the water present on the windshield 104. The example sensor unit position depicted in FIG. 1 should not be construed as limiting, and the sensor unit 110 may be disposed at any location in proximity to the windshield 104 that may enable the sensor unit 110 to effectively capture the inputs described above.

In some aspects, the first and second wipers 106, 108 may be configured to wipe the water from the sensor unit's FOV on the windshield 104, when the first and second wipers 106, 108 move. The vehicle 102 may be configured to automatically control the wiper movement based on the inputs captured by the sensor unit 110. For example, the vehicle 102 may automatically increase the wiper speed when the inputs indicate that the rain density or the amount of rainwater falling on the windshield 104 is increasing with time, automatically decrease the wiper speed when the inputs indicate that the rain density or the amount of rainwater falling on the windshield 104 is decreasing with time, or automatically stop the wiper speed when the inputs indicate that no rain or water may be falling on the windshield 104. The vehicle 102 may further maintain the wiper speed when the inputs indicate that the rain density is neither increasing nor decreasing with time. This may indicate that the first and second wipers 106, 108 may be moving at an optimal speed relative to the rain intensity, as the first and second wipers 106, 108 are effectively cleaning the amount of rainwater that is falling on the windshield 104 (i.e., neither over-wiping nor under-wiping).

The vehicle 102 may be configured to correlate the movement patterns associated with the first and second wipers 106, 108 with the sensor unit's FOV to effectively control the wiper movement based on the inputs captured by the sensor unit 110. Specifically, the vehicle 102 may be configured to compare the inputs captured by the sensor unit 110 at different time durations of wiper movement in the sensor unit's FOV and control the wiper movement based on the comparison. The vehicle 102 may be further configured to determine whether the water falling on the windshield 104 may be due to rainfall or a splash of water (e.g., caused due to another vehicle or a water sprinkler disposed in proximity to the vehicle 102) based on the comparison and accordingly control the wiper movement. The detailed process of controlling the wiper movement by correlating the movement patterns associated with the first and second wipers 106, 108 with the sensor unit's FOV is described below in conjunction with FIG. 2.

Although the present disclosure is described in the context of a vehicle having two wipers (i.e., the first and second wipers 106, 108), the present disclosure is not limited to such a wiper configuration. The present disclosure may be applied equally efficiently to all wiper configurations, e.g., vehicles having a single wiper, two wipers, three wipers, or the like.

The vehicle 102 implements and/or performs operations, as described here in the present disclosure, in accordance with the owner manual and safety guidelines. In addition, any action taken by a vehicle operator based on the notifications/recommendations provided by the vehicle 102 should comply with all the rules specific to the location and operation of the vehicle 102 (e.g., Federal, state, country, city, etc.). The notifications/recommendations, as provided by the vehicle 102, should be treated as suggestions and only followed according to any rules specific to the location and operation of the vehicle 102.

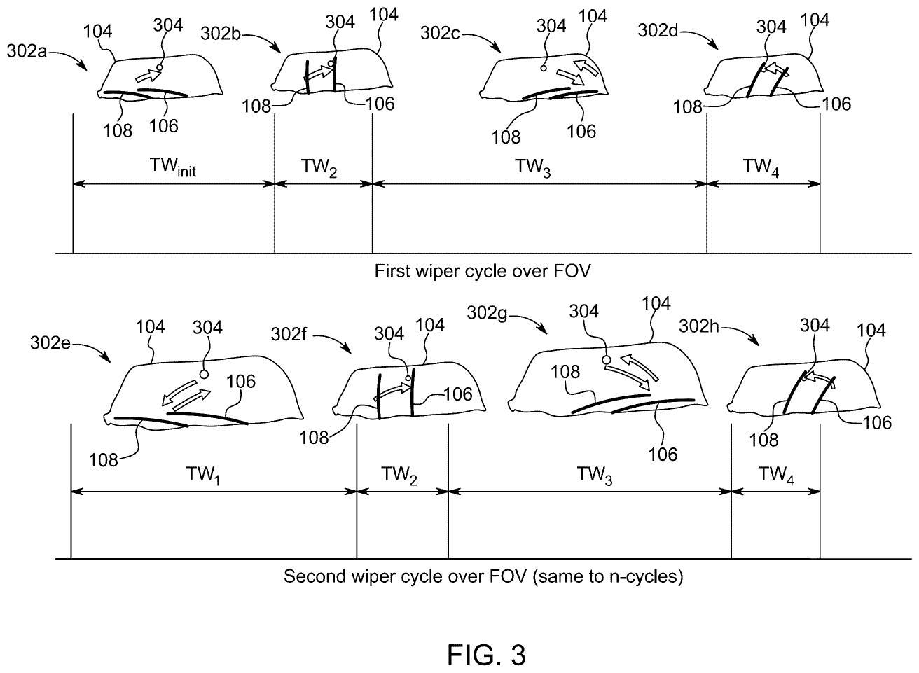

FIG. 2 depicts a block diagram of a system 200 to control operation of vehicle wipers in accordance with the present disclosure. While describing FIG. 2, references will be made to FIGS. 3, 4 and 5.

The system 200 may include the vehicle 102, a user device 202 and one or more servers 204 (or a server 204) communicatively coupled with each other via one or more networks 206. In some aspects, the user device 202 may be associated with a user/operator of the vehicle 102 and may be, for example, a mobile phone, a laptop, a tablet, a smartwatch, or any other device having communication capability. The server 204 may be part of a cloud-based computing infrastructure and may be associated with and/or include a Telematics Service Delivery Network (SDN) that provides digital data services to the vehicle 102 and other vehicles (not shown in FIG. 2) that may be part of a vehicle fleet.

In further aspects, the server 204 may store wiper information associated with typical time durations required by the first and second wipers 106, 108 to move across the sensor unit's FOV at different wiper speeds, as the first and second wipers 106, 108 move from left-to-right and then from right-to-left in a single cycle of wiper movement. For example, the server 204 may store the information indicating that the first wiper 106 takes a time duration Tex1 to enter the sensor unit's FOV from a first wiper's initial (or rest) position, the second wiper 108 takes a time duration Tex2 to enter the sensor unit's FOV from a second wiper's initial (or rest) position, the second wiper 108 takes a time duration Tex3 to re-enter the sensor unit's FOV after exiting the sensor unit's FOV in a cycle of wiper movement, and so on. Such wiper information may be based on the dimensions and types of the first and second wipers 106, 108, the windshield 104 dimensions, the sensor unit position (or the sensor unit's FOV) relative to the first/second wiper movement, and/or the like. The server 204 may transmit the wiper information to the vehicle 102 at a predefined frequency, or when the vehicle 102 transmits a request to the server 204 to obtain such information.

The network(s) 206 illustrates an example communication infrastructure in which the connected devices discussed in various embodiments of this disclosure may communicate. The network(s) 206 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 102 may include a plurality of units including, but not limited to, an automotive computer 208, a Vehicle Control Unit (VCU) 210, and a wiper control unit 212 (or unit 212). The VCU 210 may include a plurality of Electronic Control Units (ECUs) 214 in communication with the automotive computer 208.

In some aspects, the automotive computer 208 and/or the unit 212 may be installed anywhere in the vehicle 102, in accordance with the disclosure. Further, the automotive computer 208 may operate as a functional part of the unit 212. The automotive computer 208 may be or include an electronic vehicle controller, having one or more processor(s) 216 and a memory 218. Moreover, the unit 212 may be separate from the automotive computer 208 (as shown in FIG. 2) or may be integrated as part of the automotive computer 208.

The processor(s) 216 may be in communication with one or more memory devices in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable medium or memory storing a wiper control program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 210 may share a power bus with the automotive computer 208 and may be configured and/or programmed to coordinate the data between vehicle 102 systems, connected servers (e.g., the server(s) 204), and other vehicles (not shown in FIG. 2) operating as part of a vehicle fleet. The VCU 210 may include or communicate with any combination of the ECUs 214, such as a Body Control Module (BCM) 220, an Engine Control Module (ECM) 222, a Transmission Control Module (TCM) 224, a Telematics Control Unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a radio detection and ranging (radar) sensor configured for detection and localization of objects inside and outside the vehicle 102 using radio waves, sitting area buckle sensors, sitting area sensors, a light detecting and ranging (lidar) sensor, door sensors, proximity sensors, temperature sensors, wheel sensors, ambient weather sensors, vehicle internal and external cameras (e.g., the camera included in the sensor unit 110 described above in conjunction with FIG. 1), one or more rain sensors (which may be the sensor unit 110), capacitive moisture sensors, a tire pressure sensor, ultrasonic sensors, etc.

In some aspects, the VCU 210 may control vehicle operational aspects and implement one or more instruction sets received from the user device 202, from one or more instruction sets stored in the memory 218, including instructions operational as part of the unit 212.

The TCU 226 may be configured and/or programmed to provide vehicle connectivity to wireless computing systems onboard and off board the vehicle 102 and may include a Navigation (NAV) receiver 234 for receiving and processing a GPS signal, a BLE Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., the user device 202, a key fob, an NFC device, etc.), computers, and modules. The TCU 226 may be in communication with the ECUs 214 by way of a bus.

The ECUs 214 may control aspects of vehicle operation and communication using inputs from human drivers, inputs from an autonomous vehicle controller, the unit 212, and/or via wireless signal inputs received via the wireless connection(s) from other connected devices, such as the user device 202, the server(s) 204, among others.

The BCM 220 generally includes integration of sensors, vehicle performance indicators, and variable reactors associated with vehicle systems and may include processor-based power distribution circuitry that can control functions associated with the vehicle body such as lights, windows, security, camera(s), fan, headlights, audio system(s), speakers, wipers (e.g., the first and second wipers 106, 108), door locks and access control, mirrors, various comfort controls, enclosures, and/or the like. The BCM 220 may also operate as a gateway for bus and network interfaces to interact with remote ECUs (not shown in FIG. 2). In some aspects, the BCM 220 may be configured to adjust the operational parameters (e.g., activation/deactivation states, speed of movement, etc.) associated with the first and second wipers 106, 108, based on inputs or command signals obtained from the processor 216, the unit 212, and/or the like.

The DAT controller 228 may provide Level-1 through Level-3 automated driving and driver assistance functionality that may include, for example, active parking assistance, vehicle backup assistance, and adaptive cruise control, among other features. The DAT controller 228 may also provide aspects of user and environmental inputs usable for user authentication.

In some aspects, the automotive computer 208 may connect with an infotainment system 238 (or a vehicle Human-Machine Interface (HMI)). The infotainment system 238 may include a touchscreen interface portion and may include voice recognition features, biometric identification capabilities that can identify users based on facial recognition, voice recognition, fingerprint identification, or other biological identification means. In other aspects, the infotainment system 238 may be further configured to receive user instructions/inputs via the touchscreen interface portion and/or display notifications/recommendations, navigation maps, etc. on the touchscreen interface portion.

The computing system architecture of the automotive computer 208, the VCU 210, and/or the unit 212 may omit certain computing modules. It should be readily understood that the computing environment depicted in FIG. 2 is an example of a possible implementation according to the present disclosure, and thus, it should not be considered limiting or exclusive.

In accordance with some aspects, the unit 212 may be integrated with and/or executed as part of the ECUs 214. The unit 212, regardless of whether it is integrated with the automotive computer 208 or the ECUs 214, or whether it operates as an independent computing system in the vehicle 102, may include a transceiver 240, a processor 242, and a computer-readable memory 244.

The transceiver 240 may be configured to receive information/inputs from one or more external devices or systems, e.g., the user device 202, the server(s) 204, and/or the like via the network 206. For example, the transceiver 240 may receive the wiper information described above from the server 204 via the network 206. Further, the transceiver 240 may transmit notifications (e.g., alert/alarm signals) to the external devices or systems. In addition, the transceiver 240 may be configured to receive information/inputs from vehicle 102 components such as the infotainment system 238, the vehicle sensory system 232 or the sensor unit 110, the TCU 226, and/or the like. Further, the transceiver 240 may transmit notifications (e.g., alert/alarm/command signals) to the vehicle 102 components such as the infotainment system 238, the BCM 220, etc.

The processor 242 and the memory 244 may be the same as or similar to the processor 216 and the memory 218, respectively. In some aspects, the processor 242 may utilize the memory 244 to store programs in code and/or to store data for performing aspects in accordance with the disclosure. The memory 244 may be a non-transitory computer-readable medium or memory storing the wiper control program code. In some aspects, the memory 244 may be configured to store the wiper information described above that the vehicle 102 obtains from the server 204.

In operation, the processor 242 may continuously (or at a predefined frequency) obtain inputs from the sensor unit 110, via the transceiver 240 (e.g., when the vehicle ignition may be switched ON). The processor 242 may analyze the obtained inputs and may determine a water presence on the windshield 104 in the sensor unit's FOV based on the input analysis when, e.g., water (e.g., rain water or a splash of water) may fall on the windshield 104. Responsive to determining the water presence on the windshield 104 in the sensor unit's FOV based on the obtained inputs, the processor 242 may transmit a command signal to the BCM 220 to activate an initial or “first” cycle of wiper movement of the first and second wipers 106, 108.

Responsive to the first cycle getting activated, the first and second wipers 106, 108 may move from a deactivated state (e.g., when the first and second wipers 106, 108 are not moving) to an activated state (e.g., when the first and second wipers 106, 108 are moving). In some aspects, responsive to the first cycle getting activated, the first and second wipers 106, 108 may start to move simultaneously at a predefined initial wiper speed. In some aspects, the first and second wipers 106, 108 may always move at the same speed when the first and second wipers 106, 108 are in the activated state.

In further aspects, responsive to the first cycle getting activated or responsive to determining the water presence on the windshield 104, the processor 242 may fetch the wiper information from the memory 244. Based on the wiper information, the processor 242 may determine the typical time durations that the first and second wipers 106, 108 may require to move across the sensor unit's FOV (e.g., at the predefined initial wiper speed). In some aspects, the processor 242 may also determine these time durations in real-time, e.g., in addition to or instead of using the wiper information obtained from the memory 244/server 204. The concept of time durations that the first and second wipers 106, 108 require to move across the sensor unit's FOV is described below in detail in conjunction with FIG. 3.

FIG. 3 depicts example views 302a-h of the windshield 104 and the first/second wipers 106, 108, as seen from inside the vehicle 102. In each view 302a-h, the first and second wipers 106, 108 are shown at different stages of wiper movement. Further, in each view 302a-h, the sensor unit's FOV is depicted as FOV 304. Since the sensor unit 110 is disposed behind the rear view mirror 112 and at the center top portion of the windshield 104 (as described above in conjunction with FIG. 1), a person ordinarily skilled in the art may appreciate that the FOV 304 is disposed in proximity to the center top portion of the windshield 104.

The example depiction of the wiper movement and the FOV position on the windshield 104 in the views 302a-h should not be construed as limiting. The views 302a-h are shown just for illustrative purpose, and the present disclosure may be equally applicable to other types of wiper movements and/or FOV positions on the windshield 104.

In an exemplary aspect, the view 302a depicts a scenario where the first and second wipers 106, 108 are in their respective initial or rest positions (e.g., a first wiper's initial position and a second wiper's initial position). In an exemplary aspect where the first and second wipers 106, 108 move from left-to-right and then from right-to-left in a single cycle of wiper movement, the first wiper's initial position and the second wiper's initial position may be the left-most positions of the first and second wipers 106, 108, as depicted in the view 302a.

When the first cycle gets activated, the first and second wipers 106, 108 start to move at the predefined initial wiper speed from left-to-right. In some aspects, the first wiper 106 may require a time duration TWᵢₙᵢₜ (or a “first” time duration) to move from the first wiper's initial position to a position where the first wiper 106 enters the FOV 304 for a first time in the first cycle, as depicted in the view 302b. Stated another way, the time duration TWᵢₙᵢₜ may be a time required by the first wiper 106 to enter the FOV 304 the first time in the first cycle (or when the first cycle of wiper movement is activated).

As the first and second wipers 106, 108 continue to move from left-to-right in the first cycle, the first wiper 106 may exit the FOV 304 and the second wiper 108 may enter the FOV 304 for the first time in the first cycle. In some aspects, a time duration TW₂ (or a “third” time duration) may be a time required by the second wiper 108 to enter the FOV 304 for the first time in the first cycle after the first wiper 106 exits the FOV 304 for the first time in the first cycle.

Further, as the first and second wipers 106, 108 continue to move from left-to-right in the first cycle, the second wiper 108 may exit the FOV 304 and may reach its intermediate stop state (which may be a right-most position of the first and second wipers 106, 108), as shown in the view 302c. In some aspects, a time duration TW₃ (or a “second” time duration) may be a time required by the second wiper 108 to re-enter the FOV 304 after exiting the FOV 304 the first time in the first cycle. Stated another way, the time duration TW₃ may be the time required by the second wiper 108 to exit the FOV 304 for the first time in the first cycle and reach to its intermediate stop state (as shown in the view 302c) when the second wiper 108 is moving from left-to-right, and then the second wiper 108 may move back to re-enter the FOV 304 from the intermediate stop state (as shown in the view 302d) when the second wiper 108 is moving from right-to-left.

As the first and second wipers 106, 108 continue to move from right-to-left after initiating their “return movement” from the intermediate stop state to their respective initial states, the first wiper 106 may enter the FOV 304 the second time in the first cycle after the second wiper 108 exits the FOV 304 the second time in the first cycle. In some aspects, a time duration TW₄ (or a “fourth” time duration) may be a time required by the first wiper 106 to enter the FOV 304 a second time in the first cycle after the second wiper 108 exits the FOV 304 the second time in the first cycle.

The first and second wipers 106, 108 may continue to move from right-to-left and return to their respective initial states, as shown in the view 302e. In some aspect, the first cycle of wiper movement may end or be complete when the first and second wipers 106, 108 return to their respective initial states (after moving from the left-to-right and then from right-to-left).

Stated another way, the first and second wipers 106, 108 return to their respective initial states at the end of the first cycle.

A person ordinarily skilled in the art may appreciate from the description above that the time durations TWᵢₙᵢₜ, TW₂, TW₃ and TW₄ (and the additional time durations described later below) are based on the movements of the first and second wipers 106, 108 on the windshield 104. Specifically, these time durations are based on the speed at which the first and second wipers 106, 108 may be moving on the windshield 104. Further, in some aspects, when the first and second wipers 106, 108 are moving optimally at the same speed (i.e., when no wiper is faulty) and the wiper speed is not changed within the first cycle, TW2 may be substantially equivalent to TW4, as a distance “D” between the first and second wipers 106, 108 is constant when the first and second wipers 106, 108 move across the FOV 304 or across the windshield's center portion.

Responsive to determining the time durations described above in real-time or based on the wiper information obtained from the server 204, and responsive to activating the first cycle of wiper movement (as described above), the processor 242 may determine the rain density or the amount of water that may be falling on or getting added to the windshield 104 in the FOV 304 for each time duration, based on the inputs obtained from the sensor unit 110. For example, based on the inputs obtained from the sensor unit 110, the processor 242 may determine that “TW_{init-RD}” amount of water (or a “first amount” of water) may have fallen on or been added to the windshield 104 in the FOV 304 during the time duration TWᵢₙᵢₜ, “TW_{2-RD}” amount of water (or a “third amount” of water) may have been added to the windshield 104 in the FOV 304 during the time duration TW₂, “TW_{3-RD}” amount of water (or a “second amount” of water) may have been added to the windshield 104 in the FOV 304 during the time duration TW₃, and “TW_{4-RD}” amount of water (or a “fourth amount” of water) may have been added to the windshield 104 in the FOV 304 during the time duration TW₄.

Responsive to determining the amounts of water added to the windshield 104 in the FOV 304 at the different time durations described above, the processor 242 may first determine whether the water presence on the windshield 104 may be due to rainfall or a splash of water that may have been added to the windshield 104. To make this determination, the processor 242 may first compare TW_{init-RD} with a first threshold (which may be pre-stored in the memory 244). The processor 242 may cause, via the BCM 220, the first and second wipers 106, 108 to move at a first speed (which may be a fast speed) responsive to determining that TW_{init-RD} is greater than the first threshold. Stated another way, the processor 242 may cause the first and second wipers 106, 108 to move at a fast speed when the processor 242 determines that a large amount of water may have fallen on the windshield 104 in the FOV 304 during the time duration TWᵢₙᵢₜ.

Responsive to causing the first and second wipers 106, 108 to move at a fast speed (i.e., responsive to determining that TW_{init-RD} is greater than the first threshold), the processor 242 may calculate a first difference between TW_{3-RD} and TW_{init-RD} (which may TW_{init-RD}−TW_{3-RD}). The processor 242 may then control the operation of the first and second wipers 106, 108 based on the first difference, as described below.

In some aspects, the processor 242 may compare the first difference with a second threshold (which, in some aspects, may be close to zero) and determine whether the water on the windshield 104 in the FOV 304 may be due to rainfall or a splash of water based on the comparison. Specifically, the processor 242 may determine that the water on the windshield 104 in the FOV 304 may be due to heavy rainfall if the first difference may be less than the second threshold or close to zero. A person ordinarily skilled in the art may appreciate that when the vehicle 102 may be experiencing heavy rainfall, the amount of water falling on the windshield 104 may be high. Therefore, during such scenarios, the amount of water that gets added to the windshield 104 in the FOV 304 during the time duration TWᵢₙᵢₜ (i.e., TW_{init-RD}) may be high, and the amount of water that gets added to the windshield 104 in the FOV 304 during the time duration TW₃ (i.e., TW_{3-RD}) may also be high. In such cases, the difference between these two “high” amounts may be small, e.g., less than the second threshold. Therefore, the processor 242 determines that the water on the windshield 104 in the FOV 304 may be due to heavy rainfall if the first difference is less than the second threshold or close to zero.

On the other hand, the processor 242 may determine that the water on the windshield 104 in the FOV 304 may be due to a splash of water if the first difference may be greater than the second threshold. A person ordinarily skilled in the art may appreciate that when the splash of water falls on the windshield 104 and the first and second wipers 106, 108 wipe the windshield 104 at a fast speed, the water on the windshield 104 may quickly get cleaned (and no additional water may fall on the windshield 104). Therefore, during such scenarios, the amount of water that gets added to the windshield 104 in the FOV 304 during the time duration TW₃ (i.e., TW_{3-RD}) may be very small or close to zero. In such cases, the difference between TW_{init-RD} and TW_{3-RD} may be high (e.g., greater than the second threshold) as TW_{init-RD} may be substantially greater than TW_{3-RD}. Therefore, the processor 242 determines that the water on the windshield 104 in the FOV 304 may be due to a splash of water if the first difference is greater than the second threshold.

Responsive to determining that the water on the windshield 104 in the FOV 304 may be due to heavy rainfall, the processor 242 may cause the first and second wipers 106, 108 to continue to move at the first speed (i.e., the fast speed). On the other hand, responsive to determining that the water on the windshield 104 in the FOV 304 may be due to a splash of water, the processor 242 may cause the first and second wipers 106, 108 to move at a reduced speed (e.g., a second speed). In some aspects, the second speed may be less than the first speed, and/or may be equivalent to zero. Stated another way, in some aspects, responsive to determining that the water on the windshield 104 in the FOV 304 may be due a splash of water, the processor 242 may cause the first and second wipers 106, 108 to stop and not move to subsequent cycles of wiper movement (e.g., when TW_{3-RD} may be equivalent to zero, indicating that all water is wiped off the windshield 104).

In further aspects, the processor 242 may determine that the vehicle 102 may be experiencing rain (but not necessarily heavy rainfall) when the processor 242 determines that TW_{init-RD} may be less than the first threshold. In this case, responsive to determining that TW_{init-RD} is less than the first threshold, the processor 242 may cause, via the BCM 220, the first and second wipers 106, 108 to move at a third speed (which may be less than the first speed or the fast speed described above).

Furthermore, responsive to determining that TW_{init-RD} is less than the first threshold (i.e., the vehicle 102 is experiencing rain, as described above) or responsive to determining that the first difference may be less than the second threshold (i.e., the vehicle 102 is experiencing heavy rainfall, as described above), the processor 242 may transmit a command signal to the BCM 220 to activate a second or subsequent cycle of wiper movement of the first and second wipers 106, 108. The second cycle of wiper movement may be similar to the first cycle of wiper movement, and the first and second wipers 106, 108 may move in a similar manner as described above in the second cycle. Example views of wiper movement in the second cycle are shown in FIG. 3.

In the second cycle of wiper movement, the first and second wipers 106, 108 may start to move left-to-right from their respective initial positions. In some aspects, a time duration TW₁ (or a “fifth” time duration) may be a time required by the first wiper 106 to enter the FOV 304 for a first time in the second cycle (as shown in the view 302f) after exiting the FOV 304 for the second time in the first cycle.

Further, in the similar manner as described above, the time duration TW₂ in the second cycle (or a “seventh” time duration) may be a time required by the second wiper 108 to enter the FOV 304 for the first time in the second cycle after the first wiper 106 exits the FOV 304 for the first time in the second cycle. The time duration TW₃ in the second cycle (or a “sixth” time duration) may be a time required by the second wiper 108 to re-enter the FOV 304 after exiting the FOV 304 in the second cycle. Stated another way, the time duration TW₃ in the second cycle may be the time required by the second wiper 108 to exit the FOV 304 for the first time in the second cycle and reach to its intermediate stop state (as shown in the view 302g) when the second wiper 108 is moving from left-to-right, and the second wiper 108 then may move back to re-enter the FOV 304 from the intermediate stop state (as shown in the view 302h) when the second wiper 108 is moving from right-to-left.

Furthermore, the time duration TW₄ in the second cycle (or an “eighth” time duration) may be a time required by the first wiper 106 to enter the FOV 304 a second time in the second cycle after the second wiper 108 exits the FOV 304 the second time in the second cycle.

The processor 242 may determine the time durations associated with the wiper movement in the second cycle based on the wiper information and/or in real-time, as described above. Responsive to determining the time durations associated with the wiper movement in the second cycle, the processor 242 may determine the rain density or the amounts of water that may be getting added to the windshield 104 in the FOV 304 for each time duration based on the inputs obtained from the sensor unit 110, in the similar manner as described above. For example, based on the inputs obtained from the sensor unit 110, the processor 242 may determine that “TW_{1-RD}” amount of water (or a “fifth amount” of water) may have fallen on or been added to the windshield 104 in the FOV 304 during the time duration TW₁, “TW_{2-RD}” amount of water (or a “seventh amount” of water) may have been added to the windshield 104 in the FOV 304 during the time duration TW₂ in the second cycle, “TW_{3-RD}” amount of water (or a “sixth amount” of water) may have been added to the windshield 104 in the FOV 304 during the time duration TW₃ in the second cycle, and “TW_{4-RD}” amount of water (or an “eighth amount” of water) may have been added to the windshield 104 in the FOV 304 during the time duration TW₄ in the second cycle.

Responsive to determining the amounts of water added to the windshield 104 in the FOV 304 for the time durations described above in the second cycle, the processor 242 may first perform a comparison analysis between TW_{init-RD}, TW_{1-RD}, TW_{2-RD}, TW_{3-RD} and TW_{4-RD}, to determine whether the vehicle 102 may be experiencing continuous rain and/or whether the first and/or second wipers 106, 108 are operating optimally.

In some aspects, to perform the comparison analysis, the processor 242 may compare TW_{3-RD}, TW_{init-RD} and TW_{2-RD}. Since the time duration TW₃ is greater than TWᵢₙᵢₜ, which in turn is greater than TW₂ (as apparent from the views 302a-c depicted in FIG. 3), TW_{3-RD} may be greater than TW_{init-RD}, which in turn may be greater than TW_{2-RD} when the vehicle 102 may be experiencing continuous rain and the first and second wipers 106, 108 may be operating optimally. In some aspects, the processor 242 may determine that the first and/or second wipers 106, 108 may be faulty when TW_{3-RD} may not be greater than TW_{init-RD}, and/or when TW_{init-RD} may not be greater than TW_{2-RD}. A person ordinarily skilled in the art may appreciate that such a scenario may indicate that the first and/or second wipers 106, 108 may not be wiping the windshield 104 properly and may be faulty.

In further aspects, to perform the comparison analysis, the processor 242 may compare TW_{2-RD} with TW_{4-RD}, and TW_{1-RD} with TW_{3-RD}. Since the time durations TW_{2-RD} and TW_{4-RD} are equivalent, and the time durations TW_{1-RD} and TW_{3-RD} are also equivalent (as apparent from the views 302b-h depicted in FIG. 3), TW_{2-RD} may be substantially equivalent to TW_{4-RD} and TW_{1-RD} may be substantially equivalent to TW_{3-RD} when the vehicle 102 may be experiencing continuous rain and the first and second wipers 106, 108 may be operating optimally. In some aspects, the processor 242 may determine that the first and/or second wipers 106, 108 may be faulty when TW_{2-RD} may not be substantially equivalent to TW_{4-RD} and/or TW_{1-RD} may not be substantially equivalent to TW_{3-RD}. Responsive to determining that the first and/or second wipers 106, 108 may be faulty, the processor 242 may output, via the transceiver 240, a maintenance notification on the user device 202 and/or the infotainment system 238, indicating to the vehicle operator that the first and/or second wipers 106, 108 may require replacement or repair.

In some aspects, the processor 242 may determine that the vehicle 102 may be experiencing continuous rain and the first and second wipers 106, 108 may be operating optimally when the processor 242 determines that TW_{3-RD} is greater than TW_{init-RD}, TW_{init-RD} is greater than TW_{2-RD}, TW_{2-RD} is substantially equivalent to TW_{4-RD}, and TW_{1-RD} is substantially equivalent to TW_{3-RD}. Responsive to determining that the vehicle 102 may be experiencing continuous rain and the first and second wipers 106, 108 may be operating optimally, the processor 242 may determine whether the rain is steady, increasing, decreasing, or stopping with time and accordingly control the wiper speed, as described below.

To determine whether the rain is steady, increasing, decreasing, or stopping with time, the processor 242 may compare the amounts of water falling on the windshield 104 in the FOV 304 during similar time durations within the same cycle (e.g., within the first cycle or the second cycle) or across successive cycles (e.g., across the first and second cycles). For example, the processor 242 may compare and calculate a second difference between TW_{3-RD} and TW_{1-RD} within the same cycle (e.g., within the second cycle, since the time durations TW₃ and TW₁ are substantially equivalent), or between TW_{4-RD} and TW_{2-RD} within the same cycle or across successive cycles (e.g., within the first or second cycles, or across the first and second cycles, since the time durations TW₂ and TW₄ are substantially equivalent), or between same TW_{i-RD} across subsequent cycles (e.g., between TW_{4-RD} in the first cycle and TW_{4-RD} in the second cycle). Responsive to calculating the second difference, the processor 242 may compare the second difference with a third threshold (which, in an exemplary aspect, may be equivalent to zero).

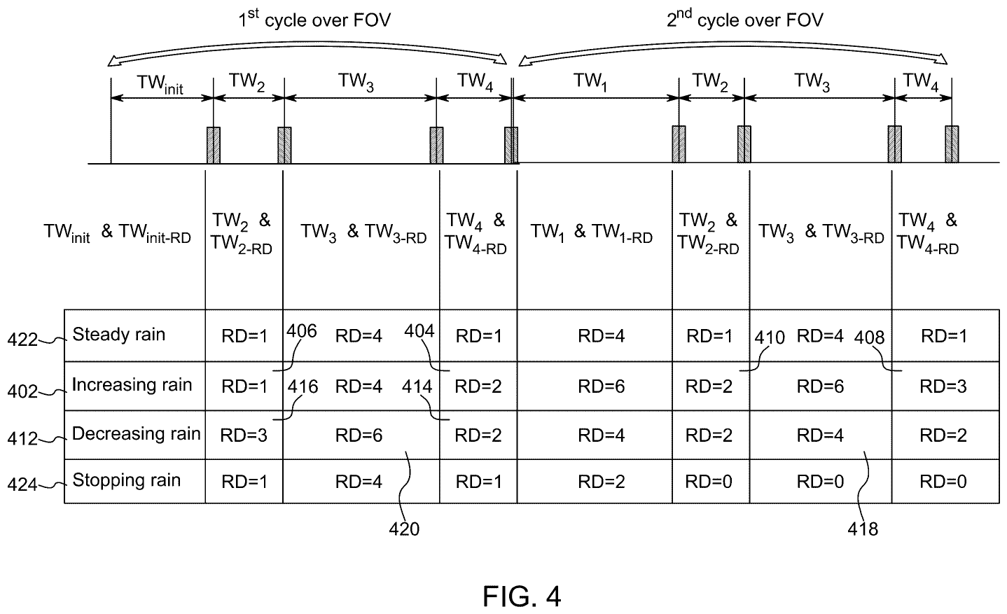

The processor 242 may determine that the rain may be increasing in density/intensity when the second difference may be greater than the third threshold (or zero). For example, as shown in a row 402 of FIG. 4, if TW_{4-RD} in the first cycle (i.e., RD=2 shown in a cell 404, where RD is “rain density” in predefined units) is greater than TW_{2-RD} in the first cycle (i.e., RD=1 shown in a cell 406), the processor 242 may determine that the second difference is greater than zero (or the third threshold), and hence the rain is increasing. In a similar manner, as shown in the row 402, if TW_{4-RD} in the second cycle (i.e., RD=3 shown in a cell 408) is greater than TW_{2-RD} in the second cycle (i.e., RD=2 shown in a cell 410) or TW_{4-RD} in the first cycle (i.e., RD=2 shown in the cell 404), the processor 242 may determine that the second difference is greater than zero (or the third threshold), and hence the rain is increasing. Responsive to determining that the rain is increasing, the processor 242 may cause the BCM 220 to increase the wiper speed associated with the first and second wipers 106, 108.

In further aspects, the processor 242 may determine that the rain may be decreasing in density when the second difference may be less than the third threshold (or zero). For example, as shown in a row 412 of FIG. 4, if TW_{4-RD} in the first cycle (i.e., RD=2 shown in a cell 414) is less than TW_{2-RD} in the first cycle (i.e., RD=3 shown in a cell 416), the processor 242 may determine that the second difference is less than zero (or the third threshold), and hence the rain is decreasing. In a similar manner, as shown in the row 412, if TW_{3-RD} in the second cycle (i.e., RD=4 shown in a cell 418) is less than TW_{3-RD} in the first cycle (i.e., RD=6 shown in a cell 420), the processor 242 may determine that the second difference is less than zero (or the third threshold), and hence the rain is decreasing. Responsive to determining that the rain is decreasing, the processor 242 may cause the BCM 220 to decrease the wiper speed associated with the first and second wipers 106, 108.

In further aspects, the processor 242 may determine that the rain may be steady (i.e., neither increasing not decreasing) in density when the second difference may be equivalent to the third threshold (or zero). For example, as shown in a row 422 of FIG. 4, if TW_{4-RD} in the first cycle is equivalent to TW_{4-RD} in the second cycle, TW_{3-RD} in the first cycle is equivalent to TW_{3-RD} in the second cycle, TW_{4-RD} in the second cycle is equivalent to TW_{2-RD} in the second cycle, and so on, the processor 242 may determine that the second difference may be equivalent to zero (or the third threshold), and hence the rain may be steady. Responsive to determining that the rain is steady, the processor 242 may maintain the wiper speed associated with the first and second wipers 106, 108 (i.e., neither increase nor decrease the wiper speed).

In further aspects, the processor 242 may determine that the rain may have stopped when the processor 242 determines that TW_{4-RD} of a cycle (e.g., the second cycle) or TW_{3-RD} and TW_{4-RD} continuously of a cycle (e.g., the second cycle) is/are equivalent to zero, as shown in a row 424 of FIG. 4. Responsive to determining that the rain may have stopped, the processor 242 may disable activation of a subsequent cycle of wiper movement associated with the first and second wiper 106, 108. For example, in this case, the processor 242 may not activate a third cycle of wiper movement when TW_{3-RD} and TW_{4-RD} of the second cycle may be equivalent to zero.

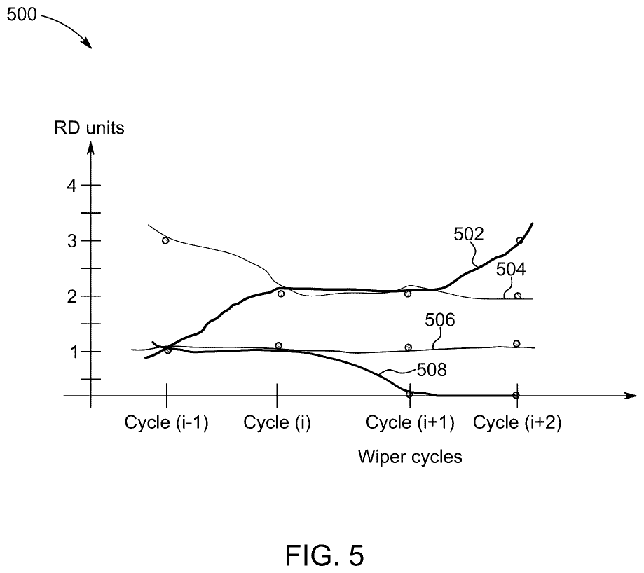

Example trend lines associated with rain density (RD) measurements for a specific time duration (e.g., TW₂) across different cycles of wiper movement are shown as a graph 500 in FIG. 5. Y-axis of graph 500 depicts RD units (or RD scores/values)/TW_{2-RD}, and X-axis depicts different cycles of wiper movement. As shown in a trend line 502, TW_{2-RD} or RD units increase with subsequent cycles of wiper movement when the rain is increasing. In this case, the processor 242 may increase the wiper speed associated with the first and second wiper 106, 108. Further, as shown in a trend line 504, TW_{2-RD} or RD units decrease with subsequent cycles of wiper movement when the rain is decreasing. In this case, the processor 242 may decrease the wiper speed associated with the first and second wiper 106, 108.

Furthermore, as shown in a trend line 506, TW_{2-RD} or RD units may remain steady in subsequent cycles of wiper movement when the rain is steady. In this case, the processor 242 may maintain the wiper speed associated with the first and second wiper 106, 108. Further, as shown in a trend line 508, TW_{2-RD} or RD units may drop to zero when the rain stops. In this case, the processor 242 may disable activation of subsequent wiper cycles associated with the first and second wiper 106, 108.

A person ordinarily skilled in the art may appreciate from the description above that since the processor 242 measures the rain densities at different time durations of wiper movement and compares the rain densities associated with “similar” time durations, the determination of increasing/decreasing/steady rainfall is highly accurate, and hence the efficiency of wiper speed control is greatly enhanced. Further, by using the systems and methods described in the present disclosure, the wiper speed transitions can be made mid-wipe as opposed to having to wait until after a wipe is performed or a cycle is completed. Furthermore, the processor 242 performs wiper health evaluation and determines whether the first and/or second wipers 106, 108 may be faulty and accordingly notifies the vehicle operator so that wiper repair/replacement can be made in a timely manner.

In additional aspects, the present disclosure may also apply to a wiper configuration where only one wiper (e.g., the first wiper 106) cleans/wipes the sensor unit's FOV, instead of both the first and second wipers 106, 108 cleaning the sensor unit's FOV as described above. In this case, the sensor unit's FOV may get cleaned twice in a wiper movement cycle (as opposed to four times as described above). Further, in this case, the first time duration of the wiper entering the sensor unit's FOV may be longer than the second time duration, because the wiper will travel a longer arc (from its rest position to the sensor unit's FOV) than the arc from the end or intermediate point to the sensor unit's FOV.

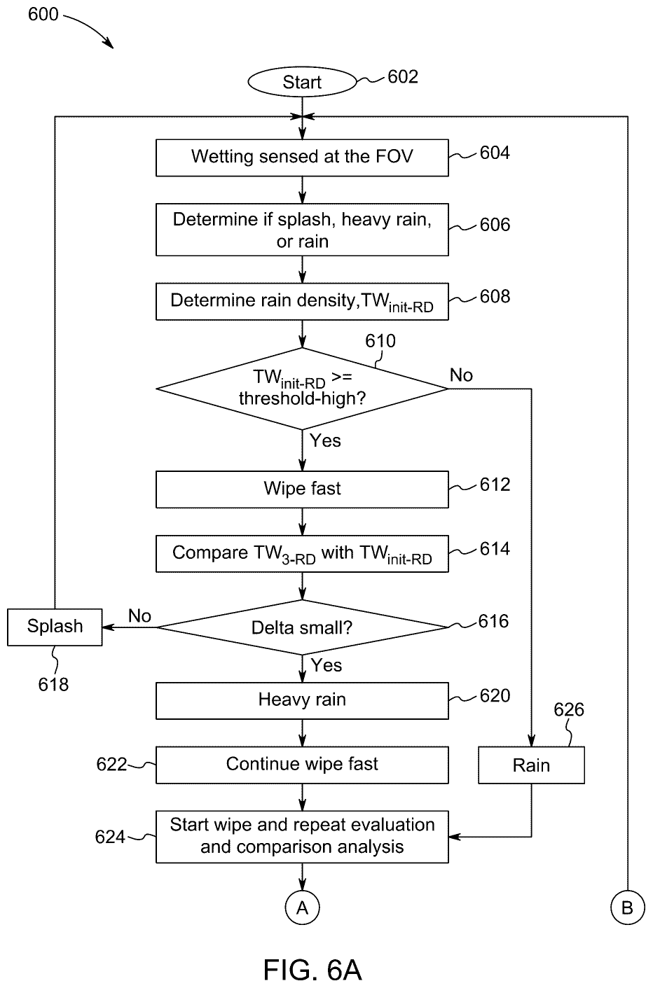

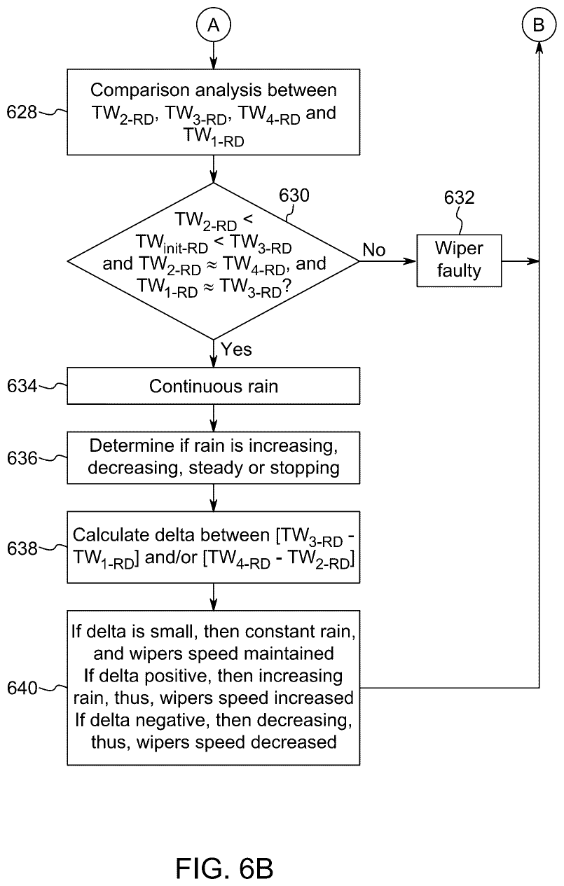

FIGS. 6A and 6B depicts a flow diagram of an example method 600 to control operation of vehicle wipers in accordance with the present disclosure. FIGS. 6A and 6B may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 600 starts at step 602. At step 604, the method 600 may include

determining or sensing, by the processor 242, wetting or water presence on the windshield 104 in the FOV 304 based on the inputs obtained from the sensor unit 110. At step 606, the method 600 may include determining, by the processor 242, whether the vehicle 102/windshield 104 may be experiencing heavy rainfall, a splash of water or rain (i.e., not heavy rainfall). In some aspects, to make such determination, the processor 242 may first determine TW_{init-RD} based on the inputs obtained from the sensor unit 110 as described above, at step 608.

At step 610, the method 600 may include determining, by the processor 242, whether TW_{init-RD} is greater than the first threshold. At step 612, the method 600 may include causing, by the processor 242, the first and second wipers 106, 108 to wipe fast, responsive to determining that TW_{init-RD} is greater than the first threshold. At step 614, the method 600 may include comparing, by the processor 242, TW_{3-RD} with TW_{init-RD}. At step 616, the method 600 may include determining, by the processor 242, whether a delta or difference between TW_{3-RD} and TW_{init-RD} is small.

The processor 242 may determine that the vehicle 102/windshield 104 may have experienced a splash of water (as shown by a block 618 in FIGS. 6A and 6B) when the delta is not small. On the other hand, the processor 242 may determine that the vehicle 102/windshield 104 may be experiencing heavy rainfall (as shown by a block 620 in FIGS. 6A and 6B) when the delta is small. Responsive to determining that the vehicle 102/windshield 104 may be experiencing heavy rainfall, the processor 242 may cause the first and second wipers 106, 108 to continue to move at the fast speed, at a step 622.

At step 624, the processor 242 may start wipe and repeat evaluation and comparison analysis. In some aspects, when the processor 242 determines at the step 610 that TW_{init-RD} is less than the first threshold, the processor 242 may determine that the vehicle 102/windshield 104 may be experiencing rain (e.g., moderate rain and not heavy rainfall), as shown by a block 626 in FIGS. 6A and 6B. Responsive to such determination, the method 600 moves to the step 624 described above.

To perform the analysis at the step 624, the processor 242 may perform comparison analysis between TW_{2-RD}, TW_{3-RD}, TW_{4-RD}, and TW_{1-RD}, as described above in conjunction with FIG. 2, at a step 628. At step 630, the method 600 may include determining, by the processor 242, whether TW_{3-RD} is greater than TW_{init-RD}, TW_{init-RD} is greater than TW_{2-RD}, TW_{2-RD} is substantially equivalent to TW_{4-RD}, and TW_{1-RD} is substantially equivalent to TW_{3-RD}. Responsive to determining that one or more of these conditions are not met, the processor 242 may determine that the first and/or second wipers 106, 108 may be faulty at step 632. On the other hand, response to determining that all these conditions are met, the processor 242 may determine that the vehicle 102/windshield 104 may be experiencing continuous rainfall at step 634.

At step 636, the method 600 may include determining, by the processor 242, whether the rain is increasing, decreasing or steady. In an exemplary aspect, the processor 242 may make such determination by calculating a difference or delta between TW_{3-RD} and TW_{1-RD}, and/or between TW_{4-RD} and TW_{2-RD}, at step 638.

At step 640, the processor 242 may determine that the rain is steady if the delta is small or zero. In this case, the processor 242 may maintain the existing wiper speed. Further, the processor 242 may determine that the rain is increasing if the delta is positive. In this case, the processor 242 may increase the wiper speed. Furthermore, the processor 242 may determine that the rain is decreasing if the delta is negative. In this case, the processor 242 may decrease the wiper speed.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a windshield;
a sensor unit configured to determine inputs associated with a presence of water on the windshield in a sensor unit's field of view (FOV);
a first wiper and a second wiper configured to wipe the water on the windshield when the first wiper and the second wiper are activated; and
a processor configured to:
determine a first amount of water added to the windshield in the sensor unit's FOV during a first time duration and a second amount of water added to the windshield in the sensor unit's FOV during a second time duration based on the inputs obtained from the sensor unit, wherein the first time duration and the second time duration are based on movements of the first wiper and the second wiper on the windshield;
calculate a first difference between the first amount and the second amount; and
control an operation of the first wiper and the second wiper based on the first difference.

2. The vehicle of claim 1, wherein:
the first time duration is a time required by the first wiper to enter the sensor unit's FOV from a first wiper's initial position, and
the second time duration is a time required by the second wiper to re-enter the sensor unit's FOV after exiting the sensor unit's FOV.

3. The vehicle of claim 2, wherein the processor is further configured to:
determine a water presence on the windshield based on the inputs obtained from the sensor unit; and
activate a first cycle of the first wiper and the second wiper responsive to determining the water presence, wherein:
the first wiper and the second wiper are moved to an activated state from a deactivated state in the first cycle,
the first wiper returns to the first wiper's initial position and the second wiper returns to a second wiper's initial position at an end of the first cycle,
the first time duration is the time required by the first wiper to enter the sensor unit's FOV from the first wiper's initial position in the first cycle, and
the second time duration is the time required by the second wiper to re-enter the sensor unit's FOV after exiting the sensor unit's FOV in the first cycle.

4. The vehicle of claim 3, wherein the processor is further configured to:
compare the first amount with a first threshold;
cause the first wiper and the second wiper to move at a first speed responsive to determining that the first amount is greater than the first threshold; and
cause the first wiper and the second wiper to move at a second speed responsive to determining that the first amount is less than the first threshold, wherein the first speed is greater than the second speed.

5. The vehicle of claim 4, wherein the processor is further configured to:
compare the first difference with a second threshold responsive to determining that the first amount is greater than the first threshold;
cause the first wiper and the second wiper to continue moving at the first speed responsive to determining that the first difference is less than the second threshold; and
cause the first wiper and the second wiper to move at a third speed responsive to determining that the first difference is greater than the second threshold, wherein the third speed is less than the first speed.

6. The vehicle of claim 5, wherein the third speed is equivalent to zero.

7. The vehicle of claim 5, wherein the processor is further configured to determine a third amount of water added to the windshield in the sensor unit's FOV during a third time duration and a fourth amount of water added to the windshield in the sensor unit's FOV during a fourth time duration based on the inputs obtained from the sensor unit, wherein:
the third time duration is a time required by the second wiper to enter the sensor unit's FOV for a first time in the first cycle after the first wiper exits the sensor unit's FOV for the first time in the first cycle, and
the fourth time duration is a time required by the first wiper to enter the sensor unit's FOV a second time in the first cycle after the second wiper exits the sensor unit's FOV the second time in the first cycle.

8. The vehicle of claim 7, wherein the processor is further configured to:
activate a second cycle of the first wiper and the second wiper, responsive to determining that the first amount is less than the first threshold or the first difference is less than the second threshold; and
determine a fifth amount of water added to the windshield in the sensor unit's FOV during a fifth time duration, a sixth amount of water added to the windshield in the sensor unit's FOV during a sixth time duration, a seventh amount of water added to the windshield in the sensor unit's FOV during a seventh time duration, and an eighth amount of water added to the windshield in the sensor unit's FOV during an eighth time duration based on the inputs obtained from the sensor unit, wherein:
the fifth time duration is a time required by the first wiper to enter the sensor unit's FOV for a first time in the second cycle after exiting the sensor unit's FOV for the second time in the first cycle,
the sixth time duration is a time required by the second wiper to re-enter the sensor unit's FOV after exiting the sensor unit's FOV in the second cycle,
the seventh time duration is a time required by the second wiper to enter the sensor unit's FOV the first time in the second cycle after the first wiper exits the sensor unit's FOV the first time in the second cycle, and
the eighth time duration is a time required by the first wiper to enter the sensor unit's FOV a second time in the second cycle after the second wiper exits the sensor unit's FOV the second time in the second cycle.

9. The vehicle of claim 8, wherein the processor is further configured to:
determine that the vehicle is experiencing a continuous rainfall responsive to activating the second cycle when:
the second amount is greater than the first amount,
the first amount is greater than the third amount,
the third amount is substantially equivalent to the fourth amount, and
the fifth amount is substantially equivalent to the second amount; and
determine that at least one of the first wiper or the second wiper is faulty when at least one of:
the second amount is not greater than the first amount,
the first amount is not greater than the third amount,
the third amount is not substantially equivalent to the fourth amount, or
the fifth amount is not substantially equivalent to the second amount.

10. The vehicle of claim 9, wherein the processor is further configured to output a maintenance notification on a user device or a vehicle Human-Machine Interface (HMI) responsive to determining that at least one of the first wiper or the second wiper is faulty.

11. The vehicle of claim 9, wherein the processor is further configured to:
calculate a second difference between at least one of the sixth amount and the fifth amount, the eighth amount and the seventh amount, or the fourth amount and the third amount, responsive to determining that the vehicle is experiencing the continuous rainfall;
increase a wiper speed of movement of the first wiper and the second wiper when the second difference is greater than a third threshold;
decrease the wiper speed when the second difference is less than the third threshold; and
maintain the wiper speed when the second difference is equivalent to the third threshold.

12. The vehicle of claim 11, wherein the third threshold is equivalent to zero.

13. The vehicle of claim 9, wherein the processor is further configured to:
determine that the eighth amount is equivalent to zero responsive to determining that the vehicle is experiencing the continuous rainfall; and
disable an activation of a subsequent cycle of the first wiper and the second wiper responsive to determining that the eighth amount is equivalent to zero.

14. The vehicle of claim 1, wherein the sensor unit comprises at least one of a rain sensor or a vehicle camera.

15. A method comprising:
determining, by a processor, a first amount of water added to a windshield of a vehicle in a sensor unit's field of view (FOV) during a first time duration and a second amount of water added to the windshield in the sensor unit's FOV during a second time duration based on inputs obtained from a sensor unit, wherein:
the sensor unit is configured to determine the inputs associated with a presence of water on the windshield in the sensor unit's FOV,
the first time duration and the second time duration are based on movements of a first wiper and a second wiper on the windshield, and
the first wiper and the second wiper are configured to wipe the water on the windshield when the first wiper and the second wiper are activated;
calculating, by the processor, a difference between the first amount and the second amount; and
controlling, by the processor, an operation of the first wiper and the second wiper based on the difference.

16. The method of claim 15, wherein:
the first time duration is a time required by the first wiper to enter the sensor unit's FOV from a first wiper's initial position, and
the second time duration is a time required by the second wiper to re-enter the sensor unit's FOV after exiting the sensor unit's FOV.

17. The method of claim 16 further comprising:
determining a water presence on the windshield based on the inputs obtained from the sensor unit; and
activating a first cycle of the first wiper and the second wiper responsive to determining the water presence, wherein:
the first wiper and the second wiper are moved to an activated state from a deactivated state in the first cycle,
the first wiper returns to the first wiper's initial position and the second wiper returns to a second wiper's initial position at an end of the first cycle,
the first time duration is the time required by the first wiper to enter the sensor unit's FOV from the first wiper's initial position in the first cycle, and
the second time duration is the time required by the second wiper to re-enter the sensor unit's FOV after exiting the sensor unit's FOV in the first cycle.

18. The method of claim 17 further comprising:
comparing the first amount with a first threshold;
causing the first wiper and the second wiper to move at a first speed responsive to determining that the first amount is greater than the first threshold; and
causing the first wiper and the second wiper to move at a second speed responsive to determining that the first amount is less than the first threshold, wherein the first speed is greater than the second speed.

19. The method of claim 18 further comprising:
comparing the difference with a second threshold responsive to determining that the first amount is greater than the first threshold;
causing the first wiper and the second wiper to continue moving at the first speed responsive to determining that the difference is less than the second threshold; and
causing the first wiper and the second wiper to move at a third speed responsive to determining that the difference is greater than the second threshold, wherein the third speed is less than the first speed.

20. A non-transitory computer-readable storage medium having instructions stored thereupon which, when executed by a processor, cause the processor to:
determine a first amount of water added to a windshield of a vehicle in a sensor unit's field of view (FOV) during a first time duration and a second amount of water added to the windshield in the sensor unit's FOV during a second time duration based on inputs obtained from a sensor unit, wherein:
the sensor unit is configured to determine the inputs associated with a presence of water on the windshield in the sensor unit's FOV,
the first time duration and the second time duration are based on movements of a first wiper and a second wiper on the windshield, and
the first wiper and the second wiper are configured to wipe the water on the windshield when the first wiper and the second wiper are activated;
calculate a difference between the first amount and the second amount; and
control an operation of the first wiper and the second wiper based on the difference.
